(19) United States
(12) Patent Application Publication
(10) Pub. No.: US 2020/0317079 A1
(43) Pub. Date: Oct. 8, 2020

(54) SMART OUTLET FOR CHARGING ELECTRIC VEHICLE AND CHARGING METHOD USING THE SAME

(71) Applicant: Chargein.Co.Ltd

(72) Inventor: Young Suk CHOI, Seoul (KR)

(21) Appl. No.: 16/305,339

(22) PCT Filed: Sep. 8, 2017
(86) PCT No.: PCT/KR2017/009892

§ 371 Date: Nov. 28, 2018

(30) Foreign Application Priority Data
Sep. 9, 2016 (KR) 10-2016-0116297

(51) Int. Cl. B60L 53/66; B60L 53/64; B60L 53/16

(52) U.S. Cl. CPC B60L 53/665; H04W 4/80; B60L 53/16; B60L 53/64

(57) ABSTRACT

Provided are a smart outlet for charging an electric vehicle and a charging method utilizing the same. A smart outlet for charging an electric vehicle includes: a cost-charging determining unit which determines whether to charge by comparing a consumed electric energy of an external device corresponding to a plug coupled to the smart outlet and a predetermined allowable electric energy; a short-range wireless communication unit which receives payment information for supplying the power to the external device based on the determination of whether to charge, from a user terminal; and a power supplying unit which supplies the power to the external device.

### TECHNICAL FIELD

The present disclosure relates to a smart outlet for charging an electric vehicle and a charging method using the same.

Further, the present invention claims the benefit of Korean Patent Application No. 10-2016-0116297 filed on Sep. 9, 2016, in the Korean Intellectual Property Office, the disclosure of which is incorporated herein by reference.

### BACKGROUND ART

An electric vehicle is a vehicle which obtains a driving energy of the vehicle from an electric energy instead of burning fossil fuel like the existing vehicles. Therefore, it has lots of advantages such as no exhaust gas, very little noise, lower maintenance cost than that of the existing vehicles, and improvement of the environmental problem in accordance with the reduction of carbon dioxide.

Recently, as a result of rapid development of various technologies such as an electric motor technology and a battery technology, an interest in such electric vehicles is suddenly increasing and studies and supplies of the electric vehicles are being actively performed.

In order to utilize such electric vehicles, a process of charging the electric vehicle by supplying power is essential. In order to supply the power, chargers provided in electric vehicle charging stations or existing outlets which are disposed in the buildings to be utilized to supply the power to various electric devices may be used.

Among these methods, when the existing outlets are used, the outlets are designed for general household appliances so that it is difficult to supply high output power and separately charge for the charging of the electric vehicles. Therefore, it is inconvenient for the owner of the electric vehicle because it takes a long time to charge the electric vehicle and it is inconvenient for the owners of the buildings such as parking lots because the owner of the building cannot collect the charging cost from the owner of the electric vehicle. As a related art, there is Korean Unexamined Patent Application Publication No. 10-2016-0023020 entitled “Multi charging apparatus and multi charging method for electric transportation devices”.

### DISCLOSURE

### Technical Problem

An object of the present disclosure is to provide a smart outlet for charging an electric vehicle which determines whether to charge the cost by comparing a consumed electric energy of an external device corresponding to a plug connected to the smart outlet and a predetermined allowable electric energy and receives payment information for supplying the power to the external device based on the determination of whether to charge the cost from a user terminal, and then supplies the power to the external device.

### Technical Solution

In order to achieve the above-mentioned object, according to an aspect of the present disclosure, an electric vehicle charging smart outlet for charging an electric vehicle includes: a cost-charging determining unit which determines whether to charge by comparing a consumed electric energy of an external device corresponding to a plug coupled to the smart outlet and a predetermined allowable electric energy, a short-range wireless communication unit which receives payment information for supplying the power to the external device based on the determination of whether to charge, from a user terminal, and a power supplying unit which supplies the power to the external device.

For example, when the consumed electric energy is equal to or larger than the allowable electric energy, the short-range wireless communication unit receives the payment information from the user terminal and the power supplying unit supplies the power to the external device for a predetermined operating time corresponding to the payment information.

For example, when the consumed electric energy is smaller than the allowable electric energy, the power supplying unit consistently supplies the power to the external device until the plug is removed from the smart outlet.

For example, the electric vehicle charging smart outlet may further include a supplied electric energy information generating unit which measures a supplied electric energy supplied to the external device in real time to generate supplied electric energy information and a long-distance wireless communication unit which transmits the supplied electric energy information to a charging server in which the charging server transmits the supplied electric energy information to the user terminal in real time.

For example, when the plug is recoupled to the smart outlet within a predetermined recoupling allowable time after being removed from the smart outlet within a predetermined initial time, the power supplying unit continuously supplies the power to the external device for the predetermined operating time. For example, when the plug is recoupled to the smart outlet after a predetermined recoupling allowable time after being removed from the smart outlet within a predetermined initial time, the power supplying unit stops supplying the power to the external device.

For example, the electric vehicle charging smart outlet may further include: a refund information generating unit which generates refund information based on a ratio of a charging time generated based on a charging start time and a time when the plug is removed from the smart outlet and the predetermined operating time in which the short-range wireless communication unit transmits the refund information to the user terminal.

For example, when the smart outlet is a master outlet which controls a plurality of smart outlets installed in advance in a building, the electric vehicle charging smart outlet may further include an allowable current amount calculating unit which calculates an allowable current amount per smart outlet based on an allowable current amount of the building and the number of smart outlets which are currently supplying the power to the external device, among the plurality of smart outlets in which the short-range wireless communication unit transmits an allowable current amount per smart outlet to each of the smart outlets which are currently supplying the power to the external device, among the plurality of smart outlets.

For example, when the smart outlet is a slave outlet which is controlled by a master outlet which controls a plurality of smart outlets installed in advance in the building, the short-range wireless communication unit receives an allowable current amount per smart outlet calculated by the master outlet.

According to another aspect of the present disclosure, a charging method utilizing a smart outlet for charging an electric vehicle includes: determining whether to charge by comparing a consumed electric energy of an external device corresponding to a plug coupled to the smart outlet and a predetermined allowable electric energy by a cost-charging determining unit, receiving payment information for supplying the power to the external device from a user terminal based on the determination of whether to charge, by a short-range wireless communication unit, and supplying the power to the external device, by a power supplying unit.

### Advantageous Effects

According to the present disclosure, it is determined whether to charge the cost by comparing the consumed electric energy of the external device corresponding to the plug connected to the smart outlet and a predetermined allowable electric energy, so that a user who charges the electric vehicle is charged, but a user who uses a general electric device is not charged.

### DESCRIPTION OF DRAWINGS

FIG. 1 is a view for explaining a smart outlet for charging an electric vehicle according to an exemplary embodiment of the present disclosure.

FIG. 2 is a diagram for explaining a smart outlet for charging an electric vehicle according to an exemplary embodiment of the present disclosure.

FIG. 3 is a view for explaining a case when a smart outlet for charging an electric vehicle according to an exemplary embodiment of the present disclosure is driven as a master outlet or a slave outlet.

FIG. 4 is a flowchart for explaining a charging method according to an exemplary embodiment of the present disclosure.

### BEST MODE

Hereinafter, the most preferred exemplary embodiments of the present invention will be described in detail with reference to the accompanying drawings so that those skilled in the art may easily carry out the technical spirit of the present invention. In the figures, even though the parts are illustrated in different drawings, it should be understood that like reference numbers refer to the same or equivalent parts of the present invention throughout the several figures of the drawing. In addition, in the description of the present invention, the detailed descriptions of publicly known related constitutions or functions thereof may be omitted if they make the gist of the present invention unclear.

Hereinafter, a smart outlet for charging an electric vehicle according to an exemplary embodiment of the present disclosure and a charging method using the same will be described below in detail with reference to the accompanying drawings.

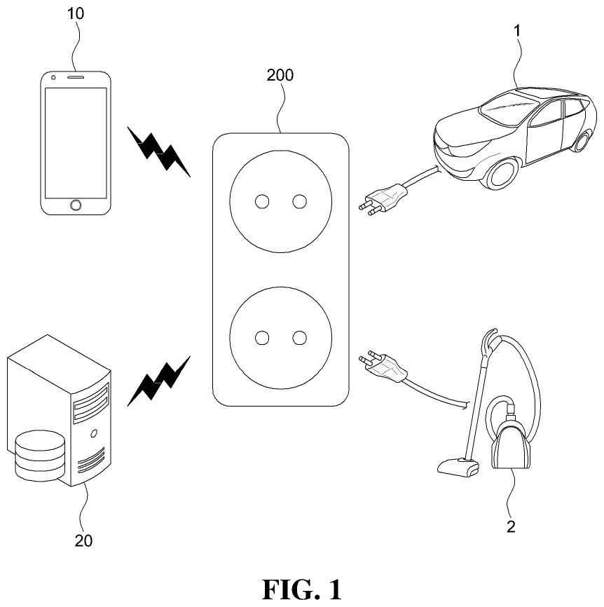

First, a smart outlet 200 for charging an electric vehicle according to an exemplary embodiment of the present disclosure will be described with reference to FIG. 1. FIG. 1 is a view for explaining a smart outlet for charging an electric vehicle according to an exemplary embodiment of the present disclosure.

As illustrated in FIG. 1, a smart outlet 200 for charging an electric vehicle according to an exemplary embodiment of the present disclosure supplies power to various external devices 1 and 2.

In this case, various external devices 1 and 2 may refer to an electric vehicle 1 which is supplied with power by plugging a plug into an outlet or various general electric devices 2 which are supplied with power by plugging a plug into the outlet.

For example, various normal electric devices 2 may refer to universal electric appliances which are disposed in buildings to be utilized in a real life, such as a vacuum cleaner, a washing machine, a lamp, an electric heater, and an air conditioner and the smart outlet 200 for charging an electric vehicle according to the exemplary embodiment of the present disclosure is not limited to outlets for supplying the power to a specific general electric device 2.

That is, the smart outlet 200 for charging an electric vehicle according to the exemplary embodiment of the present disclosure may replace an existing outlet which is previously disposed in the building and supply the power to the electric vehicle 1 or to various general electronic devices 2 to which the power is supplied by a general outlet if necessary.

For example, when the smart outlet 200 for charging an electric vehicle according to the exemplary embodiment of the present disclosure supplies the power to the electric vehicle 1, the smart outlet induces to make the payment through a short-range wireless communication with the user terminal 10 to supply the power for a fee.

In this case, the user terminal 10 is a terminal which is carried by an owner of the electric vehicle 1 and includes various mobile devices such as a smart phone, a smart pad, and PDA, but the present disclosure is not limited thereto.

For example, when the smart outlet 200 for charging an electric vehicle according to the exemplary embodiment of the present disclosure supplies the power to various general electric devices 2, the smart outlet supplies the power for free without separate payment so as to replace the general outlet of the related art.

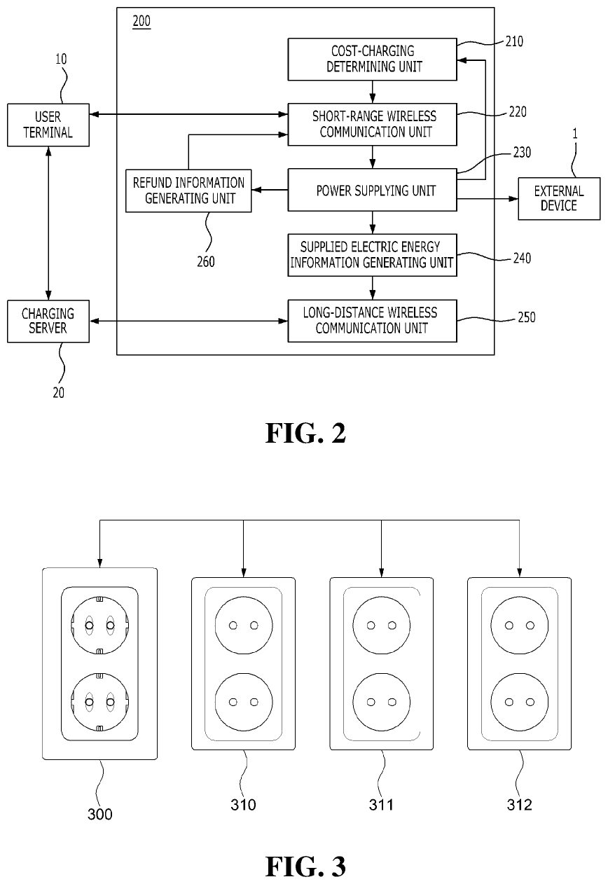

In this case, a more specific method for determining whether to charge the cost by distinguishing the electric vehicle 1 and various general electronic devices 2 by the smart outlet 200 for charging an electric vehicle according to the exemplary embodiment of the present disclosure will be described below with reference to FIG. 2.

According to an exemplary embodiment, the smart outlet 200 for charging an electric vehicle may perform a long-distance wireless communication with a charging server 20.

Now, a smart outlet 200 for charging an electric vehicle according to an exemplary embodiment of the present disclosure will be described with reference to FIG. 2.

FIG. 2 is a diagram for explaining a smart outlet for charging an electric vehicle according to an exemplary embodiment of the present disclosure.

As illustrated in FIG. 2, the smart outlet 200 for charging an electric vehicle according to an exemplary embodiment of the present disclosure includes a cost-charging determining unit 210, a short-range wireless communication unit 220, and a power supplying unit 230.

As illustrated in FIG. 2, the smart outlet 200 for charging an electric vehicle according to an exemplary embodiment of the present disclosure may further include any one of a supplied electric energy information generating unit 240, a long-distance wireless communication unit 250, and a refund information generating unit 260, but the present disclosure is not limited thereto.

For example, the smart outlet 200 for charging an electric vehicle according to an exemplary embodiment of the present disclosure may be provided to charge an electric vehicle, but the present disclosure is not limited thereto.

The cost-charging determining unit 210 determines whether to charge by comparing a consumed electric energy of the external device 1 corresponding to a plug coupled to the smart outlet 200 and a predetermined allowable electric energy.

For example, the plug may refer to a mechanism which connects the external device 1 with the smart outlet 200 for charging an electric vehicle to each other to supply power to the external device 1 and the present disclosure is not limited to a specific plug.

For example, the external device 1 may be various devices which are supplied with power from the outlet as well as general electric appliances and the present disclosure is not limited to a specific external device 1.

For example, the consumed electric energy of the external device 1 may be measured by measuring an initial electric energy transmitted from the power supplying unit 230 to the external device 1 by a smart electricity meter (not illustrated), determined based on at least one of a rated capacity, a rated voltage, and a rated current set in advance for every external device 1, or calculated by various methods for calculating the electric energy. Further, the present disclosure may calculate the consumed electric energy of the external device 1 by utilizing various methods in addition to the above-described method, but is not limited thereto.

For example, the predetermined allowable electric energy may be stored in advance in the cost-charging determining unit 210 and may refer to an electric energy which is a criterion for determining whether to supply the power for free or for a fee. For example, the unit of the consumed electric energy or the predetermined allowable electric energy of the external device 1 may refer to various units indicating an electric energy consumed for an hour as well as kWh or Wh.

The short-range wireless communication unit 220 receives payment information for supplying the power to the external device 1 based on the determination of whether to charge, from the user terminal 10.

For example, the short-range wireless communication unit 220 may refer to various short-range wireless communication modules for providing a wireless personal area network (WPAN) as well as a Bluetooth module, a ZigBee module, and a UWB module for communication with the user terminal 10 and the short-range wireless communication module 220 of the present disclosure is not limited to a specific wireless communication module.

When as a determination result by the cost-charging determining unit 210, the external device 1 is an object to be charged that needs to use the power for a fee such as an electric vehicle, the short-range wireless communication unit 220 may receive the payment information from the user terminal 10.

In contrast, when as a determination result by the cost-charging determining unit 210, the external device 1 is an object to which the power needs to be supplied for a free such as various general electric appliances, the short-range wireless communication unit 220 may not receive the payment information from the user terminal 10.

For example, the payment information is information which is generated through communication between the user terminal 10 and the charging server 20 through an application installed in advance in the user terminal 10 and may refer to various information related to payment including information on an amount paid by the user terminal 10 to the charging server 20 and information for requesting to supply the power for a fee during an operating time corresponding to an amount paid by the user terminal 10.

For example, when the user terminal 10 requests the charging server 20 to charge for three hours and makes a payment for a cost corresponding to three hours, the payment information may refer to information requesting to supply the power for three hours.

For example, the payment information may refer to various information such as charging coins, charging coupons, and charging mileages which are generated in advance through communication between the user terminal 10 and the charging server 20 and stored in the user terminal 10 and the payment information according to the present disclosure is not limited to a specific type.

The power supplying unit 230 supplies the power to the external device 1.

For example, when the cost-charging determining unit 210 determines that the consumed electric energy is equal to or larger than the allowable electric energy, the short-range wireless communication unit 220 receives the payment information from the user terminal 10 and the power supplying unit 230 supplies the power to the external device 1 during a predetermined operating time corresponding to the payment information.

For example, when the consumed electric energy of the external device 1 is equal to or larger than the predetermined allowable electric energy, the corresponding external device 1 is determined as an electric vehicle. Therefore, as a result, only when the payment information is received through the short-range wireless communication unit 220, the power supplying unit 230 may supply the power to the external device 1 during the operating time corresponding to the payment information.

In this case, the predetermined allowable electric energy may be determined and stored in advance by an owner of the smart outlet 200 for charging the electric vehicle according to the exemplary embodiment of the present disclosure.

For example, if the consumed electric energy of the external device 1 is 1.3 kWh, the previously stored allowable electric energy is 1 kWh, and the operating time corresponding to the payment information is three hours, the power supplying unit 230 may supply the power to the external device 1 for three hours only when the payment information is received through the short-range wireless communication unit 220.

According to an exemplary embodiment, when the cost-charging determining unit 210 determines that the consumed electric energy is smaller than the allowable electric energy, the power supplying unit 230 may continuously supply the power to the external device 1 until the plug is removed from the smart outlet 200 according to the exemplary embodiment of the present disclosure.

For example, when the consumed electric energy of the external device 1 is smaller than the predetermined allowable electric energy, the corresponding external device 1 may be determined as a general electric appliance and as a result, the power supplying unit 230 may consistently supply the power to the corresponding external device 1 as same as the general outlet.

By doing this, the smart outlet 200 for charging an electric vehicle according to the exemplary embodiment of the present disclosure is installed in various locations including buildings or sites where existing general outlets are installed, instead of a general outlet, so that a free power supplying function for users of general electric appliances including vacuum cleaners as well as charged charging support for the users of the electric vehicles.

For example, the smart outlet 200 for charging an electric vehicle according to an exemplary embodiment of the present disclosure may further include a supplied electric energy information generating unit 240 and a long-distance wireless communication unit 250.

The supplied electric energy information generating unit 240 measures the supplied electric energy which is supplied to the external device 1 in real time to generate supplied electric energy information.

In this case, the supplied electric energy information may refer to a real-time electric energy which is supplied to the external device 1 by the power supplying unit 230.

For example, the supplied electric energy information generating unit 240 may refer to a smart electricity meter (not illustrated) for measuring an electric energy supplied in real time, but the present disclosure is not limited thereto.

The long-distance wireless communication unit 250 transmits supplied electric energy information to the charging server 20.

For example, the long-distance wireless communication unit 250 may refer to various mobile communication functions to be connected to mobile communication networks such as 3-rd generation (3G), 3-rd generation partnership project (3GPP), and long term evolution (LTE) and various wireless Internet modules to be connected to external networks such as wireless LAN (WLAN), Wi-Fi, wireless broadband (WiBro), world interoperability for microwave access (WiMax), and high speed downlink packet access (HSDPA), but the present disclosure is not limited to a specific long-distance wireless communication module.

Thereafter, the charging server 20 transmits the supplied electric energy information to the user terminal 10 in real time.

By doing this, when the user of the smart outlet 200 for charging an electric vehicle according to an exemplary embodiment of the present disclosure is a charged user for charging the electric vehicle, the user may check whether the electric vehicle is being properly charged through the user terminal 10 carried by the user in real time.

For example, when the plug is removed from the smart outlet 200 according to the exemplary embodiment of the present disclosure within a predetermined initial time and then recoupled to the smart outlet within a predetermined recoupling allowable time, the power supplying unit 230 may continuously supply the power to the external device 1 during a predetermined operating time.

For example, the power supplying unit 230 may check whether the plug is removed or recoupled, by detecting a current flowing through the plug of the external device 1, but the present disclosure is not limited thereto.

For example, the power supplying unit 230 detects the current (0.001 A or higher) after the plug is coupled to confirm whether the plug is coupled. When the plug is coupled, a timer is operated to measure a time when the plug is coupled, but the present disclosure is not limited thereto.

For example, the predetermined initial time may refer to an initial time interval calculated from a timing at which the charging to the external device 1 starts.

For example, the recoupling allowable time may refer to a time which is a criterion for continuously supplying the power to the external device 1 by utilizing the existing payment information when the plug is recoupled to the smart outlet 200 according to the exemplary embodiment of the present disclosure after being removed from the smart outlet within a predetermined initial time.

For example, the predetermined initial time and the recoupling allowable time may refer to times which are set and stored in advance by the user of the smart outlet 200 according to the exemplary embodiment of the present disclosure, but the present disclosure is not limited thereto.

For example, when the predetermined operating time corresponding to the payment information is three hours, the predetermined initial time is five minutes, and the recoupling allowable time is five seconds, if the plug is removed from the smart outlet 200 according to the exemplary embodiment of the present disclosure within five minutes after starting the charging and then recoupled to the smart outlet within five minutes from the removed time, the power supplying unit 230 continuously supplies the power to the external device 1 for three hours which is the predetermined operating time.

By doing this, even though the plug is removed from the smart outlet 200 by the mistake of the user and then the user urgently recouples the plug to the smart outlet 200, the existing payment information is held so that the user may conveniently continue to charge the electric vehicle without performing a separate refund process and repayment process.

According to the exemplary embodiment, when the process that the plug is removed from the smart outlet 200 according to the exemplary embodiment of the present disclosure and recoupled to the smart outlet within the predetermined recoupling allowable time is repeated a predetermined number of times or more within the predetermined initial time, the power supplying unit 230 may stop supplying the power to the external device 1.

For example, when the predetermined operating time corresponding to the payment information is three hours, the predetermined initial time is five minutes, and the recoupling allowable time is five seconds, if the process that the plug is removed from the smart outlet 200 according to the exemplary embodiment of the present disclosure within five minutes after starting the charging and then recoupled to the smart outlet within five seconds after the removed time is generated more than three times in total within five minutes after the charging start time, the power supplying unit 230 may stop supplying the power to the external device 1.

By doing this, when the plug is repeatedly removed and recoupled, the smart outlet 200 for charging an electric vehicle according to an exemplary embodiment of the present disclosure determines the repeated removal and recoupling of the plug as a wrongful use to stop supplying the power.

In contrast, when the plug is removed from the smart outlet 200 within the predetermined initial time and then is recoupled to the smart outlet after the predetermined recoupling allowable time, the power supplying unit 230 may stop supplying the power to the external device 1.

For example, when the predetermined operating time corresponding to the payment information is three hours, the predetermined initial time is five minutes, and the recoupling allowable time is five seconds, if the plug is removed from the smart outlet 200 according to the exemplary embodiment of the present disclosure within five minutes after starting the charging and then recoupled to the smart outlet within five seconds from the removed time, the power supplying unit 230 may not supply the power to the external device 1.

By doing this, when the other user intends a wrongful use by coupling a charging plug of the other user's electric vehicle after removing a plug of an electric vehicle of the user which is being charged from the smart outlet 200 according to the exemplary embodiment of the present disclosure, the power may not be supplied to the other user's electric vehicle.

For example, the smart outlet 200 for charging an electric vehicle according to the exemplary embodiment of the present disclosure may further include a refund information generating unit 260.

The refund information generating unit 260 generates refund information based on a ratio of a charging time generated based on a charging start time and a time when the plug is removed from the smart outlet 200 and a predetermined operating time.

In this case, the short-range wireless communication unit 220 may transmit the refund information to the user terminal 10.

For example, when the charging start time is 12:00 and the time when the plug is removed from the smart outlet 200 is 12:05, the charging time is determined as five minutes. Further, in this case, the predetermined operating time is 60 minutes, the refund information may be information indicating that 11/12 of the paid amount is refunded.

Now, a case when in a building where a plurality of smart outlets 200 for charging an electric vehicle according to an exemplary embodiment of the present disclosure is installed, the smart outlets 200 for charging an electric vehicle according to an exemplary embodiment of the present disclosure operate as a master outlet 300 or slave outlets 310, 311, and 312 will be described with reference to FIG. 3.

FIG. 3 is a view for explaining a case when a smart outlet for charging an electric vehicle according to an exemplary embodiment of the present disclosure is driven as a master outlet or a slave outlet.

The master outlet 300 is an outlet which controls a plurality of slave outlets 310, 311, and 312 and performs a function of checking whether each of the slave outlets 310, 311, and 312 is currently used and blocking an over current.

The slave outlets 310, 311, and 312 are controlled by the master outlet 300 and measure the used electric energy of the external device 1 connected thereto and an amount of current which is being currently supplied to transmit the used electric energy and the amount of current to the master outlet 300.

For example, the master outlet 300 and the slave outlets 310, 311, and 312 may exchange information with each other by utilizing various short-range wireless communications including Bluetooth.

For example, when the current amount measured in the slave outlets 310, 311, and 312 is lower than 50 mAh, the master outlet 300 may determine that the corresponding slave outlets 310, 311, and 312 are not currently used. Further, when the current amount measured in the slave outlets 310, 311, and 312 is equal to or higher than 50 mAh, the master outlet 300 may determine that the corresponding slave outlets 310, 311, and 312 are being currently used.

For example, when the smart outlet 200 for charging an electric vehicle according to an exemplary embodiment of the present disclosure is a master outlet 300 which controls a plurality of smart outlets 310, 311, and 312 installed in advance in the building, the smart outlet 200 for charging an electric vehicle according to an exemplary embodiment of the present disclosure may further include an allowable current amount calculating unit (not illustrated).

The allowable current amount calculating unit (not illustrated) calculates an allowable current amount for every smart outlet based on an allowable current amount of the building and the number of smart outlets which are currently supplying the power to the external device 1, among the plurality of smart outlets 310, 311, and 312.

In this case, the allowable current amount of the building may variably set according to the relevant regulations and the design standard of the building and the allowable current amount of a general household or building having a maximum electric energy of 3 kWh does not exceed a maximum of 20 A.

In this case, the allowable current amount of the building may be determined in advance according to any one of the relevant regulations and the design standard of the building where the smart outlet according to the exemplary embodiment of the present disclosure is installed to be stored in advance in the allowable current amount calculating unit (not illustrated).

For example, when the allowable current amount of the building is 20 A and the number of smart outlets which are currently supplying the power to the external device 1 is one, the allowable current amount calculating unit (not illustrated) may calculate 20 A of current which can be supplied by each smart outlet at maximum as the allowable current amount per smart outlet.

In the meantime, when the allowable current amount of the building is 20 A and the number of smart outlets which are currently supplying the power to the external device 1 is three, the allowable current amount calculating unit (not illustrated) may calculate 20/3 A which can be supplied by each smart outlet at maximum as the allowable current amount per smart outlet.

In this case, the short-range wireless communication unit 220 transmits the allowable current amount per smart outlet to the smart outlet which is currently supplying the power to the external device among the plurality of smart outlets to control the smart outlet which is currently supplying the power to the external device.

For example, when the smart outlet 200 for charging an electric vehicle according to the exemplary embodiment of the present disclosure is the slave outlet 310 which is controlled by the master outlet 300 which controls the plurality of smart outlets installed in advance in the building, the short-range wireless communication unit 220 may receive the allowable current amount per smart outlet calculated by the master outlet 300.

In this case, the power supplying unit 230 may supply the current corresponding to the received allowable current amount per smart outlet to the external device 1.

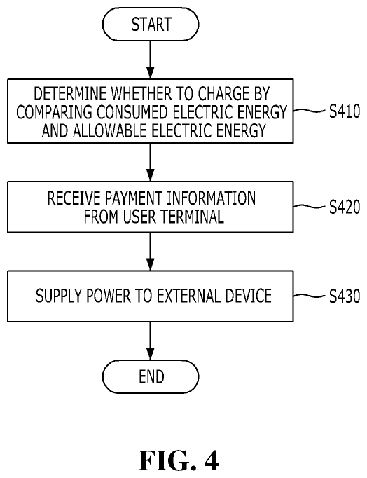

Now, a charging method according to an exemplary embodiment of the present disclosure will be described with reference to FIG. 4.

FIG. 4 is a flowchart for explaining a charging method according to an exemplary embodiment of the present disclosure.

As illustrated in FIG. 4, a charging method according to an exemplary embodiment of the present disclosure includes a step S410 of determining whether to charge by comparing a consumed electric energy and an allowable electric energy, a step S420 of receiving payment information from a user terminal, and a step S430 of supplying the power to an external device.

In the step S410, the cost-charging determining unit 210 determines whether to charge by comparing the consumed electric energy of the external device 1 corresponding to a plug coupled to the smart outlet 200 and a predetermined allowable electric energy.

In the step S420, the short-range wireless communication unit 220 receives payment information for supplying the power to the external device 1 based on the determination of whether to charge, from the user terminal 10.

In the step S430, the power supplying unit 230 supplies the power to the external device 1.

In this case, the more detailed description of the charging method according to the exemplary embodiment of the present disclosure is the same as the descriptions of the smart outlet 200 for charging an electric vehicle described with reference to FIGS. 1 to 3, so that a redundant description will be omitted.

Although the exemplary embodiment of the present disclosure has been described above, the present disclosure may be modified in various forms. Further, it is understood that those skilled in the art may perform various modifications and changes without departing from the claims of the present disclosure.

1. An electric vehicle charging smart outlet for charging an electric vehicle, comprising:
a cost-charging determining unit which determines whether to charge by comparing a consumed electric energy of an external device corresponding to a plug coupled to the smart outlet and a predetermined allowable electric energy;
a short-range wireless communication unit which receives payment information for supplying the power to the external device based on the determination of whether to charge, from a user terminal; and
a power supplying unit which supplies the power to the external device.

2. The electric vehicle charging smart outlet according to claim 1, wherein when the consumed electric energy is equal to or larger than the allowable electric energy, the short-range wireless communication unit receives the payment information from the user terminal and the power supplying unit supplies the power to the external device for a predetermined operating time corresponding to the payment information.

3. The electric vehicle charging smart outlet according to claim 1, wherein when the consumed electric energy is smaller than the allowable electric energy, the power supplying unit consistently supplies the power to the external device until the plug is removed from the smart outlet.

4. The electric vehicle charging smart outlet according to claim 2, further comprising:
a supplied electric energy information generating unit which measures a supplied electric energy supplied to the external device in real time to generate supplied electric energy information; and
a long-distance wireless communication unit which transmits the supplied electric energy information to a charging server,
wherein the charging server transmits the supplied electric energy information to the user terminal in real time.

5. The electric vehicle charging smart outlet according to claim 2, wherein when the plug is recoupled to the smart outlet within a predetermined recoupling allowable time after being removed from the smart outlet within a predetermined initial time, the power supplying unit continuously supplies the power to the external device for the predetermined operating time.

6. The electric vehicle charging smart outlet according to claim 2, wherein when the plug is recoupled to the smart outlet after the predetermined recoupling allowable time after being removed from the smart outlet within the predetermined initial time, the power supplying unit stops supplying the power to the external device.

7. The electric vehicle charging smart outlet according to claim 6, further comprising:
a refund information generating unit which generates refund information based on a ratio of a charging time generated based on a charging start time and a time when the plug is removed from the smart outlet and the predetermined operating time,
wherein the short-range wireless communication unit transmits the refund information to the user terminal.

8. The electric vehicle charging smart outlet according to claim 1, further comprising:
an allowable current amount calculating unit which calculates an allowable current amount per smart outlet based on an allowable current amount of the building and the number of smart outlets which are currently supplying the power to the external device, among the plurality of smart outlets, when the smart outlet is a master outlet which controls a plurality of smart outlets installed in advance in a building,
wherein the short-range wireless communication unit transmits an allowable current amount per smart outlet to each of the smart outlets which are currently supplying the power to the external device, among the plurality of smart outlets.

9. The electric vehicle charging smart outlet according to claim 1, wherein when the smart outlet is a slave outlet which is controlled by a master outlet which controls a plurality of smart outlets installed in advance in the building, the short-range wireless communication unit receives an allowable current amount per smart outlet calculated by the master outlet.

10. A charging method utilizing a smart outlet for charging an electric vehicle, the method comprising:
determining whether to charge by comparing a consumed electric energy of an external device corresponding to a plug coupled to the smart outlet and a predetermined allowable electric energy by a cost-charging determining unit;
receiving payment information for supplying the power to the external device from a user terminal based on the determination of whether to charge, by a short-range wireless communication unit; and
supplying the power to the external device, by a power supplying unit.
